(19) United States
(12) Patent Application Publication
(10) Pub. No.: US 2025/0155302 A1
(43) Pub. Date: May 15, 2025

(54) Glass Bead Retention Test to Evaluate Road Marking Performance

(71) Applicant: Kraton Corporation, The Woodlands, TX (US)

(72) Inventors: Peter Uthe, Savannah, GA (US); Blaisedell Willis, Savannah, GA (US); Adam Fasula, Jacksonville, FL (US); Brett Neumann, Savannah, GA (US)

(73) Assignee: Kraton Corporation, The Woodlands, TX (US)

(21) Appl. No.: 18/940,256

(22) Filed: Nov. 7, 2024

Related U.S. Application Data
(60) Provisional application No. 63/597,722, filed on Nov. 10, 2023.

(51) Int. Cl. G01L 5/00

(52) U.S. Cl. CPC G01L 5/0038; G01L 5/0052

(57) ABSTRACT

A method to evaluate the force required to dislodge glass beads from a road marking is disclosed. The method comprises: spreading a road marking formulation onto a substrate to a pre-determined thickness, positioning glass bead(s) in the road marking layer and measuring the force required to dislodge the glass bead(s) from the road marking layer with a tensile tester. The method can be used to evaluate performance of different road marking formulations with a consistent evaluation method for all formulations, and with minimal variability for the same batch of road marking formulation.

### RELATED APPLICATIONS

This application claims priority to U.S. Provisional Application No. 63/597,722, filed on Nov. 10, 2023, incorporated herein by reference in its entirety.

### FIELD

The disclosure relates generally to methods to evaluate the adhesion of glass to construction materials, and specifically to evaluating glass bead adhesion in road marking applications.

### BACKGROUND

Road surface markings, e.g., pavement markings such as sheets, paints, tapes, raised pavement markers, and individually mounted articles, guide and direct motorists and pedestrians traveling along roadways and paths. Glass beads are the source for retroreflectivity of road marking and improve visibility of the marking, especially important in low-light conditions or bad weather.

Currently there are no industry accepted test methods for directly measuring glass bead retention in road markings as a way to evaluate road marking formulations. Road trials such as those conducted in the National Transportation Product Evaluation Program (NTPEP), independent road test decks, turn-table road marking wear tests systems (e.g. BASt, AETEC), taber wear test, and others, can be used to predict real world performance of road markings. These test methods rely on the correlation between wear and measured retroreflectivity of the system. Drawbacks exist with these approaches. Road trials and test decks have extended evaluation times and are expensive. Turn-table wear tests have a moderate evaluation time and cost, but not ideal as a reasonable test to help optimize new road marking formulations. Lab-based wear testing is also used, but with limited success in correlating lab wear properties to real-world glass bead retention in roadway services. A lab-based test with shortened evaluation time that directly measures the forces contributing to glass bead retention would greatly benefit the industry in developing better performing road marking systems.

There is a need for an improved method with shortened evaluation time that directly measures the forces contributing to glass bead retention, and qualifying the mode when failure occurs, allowing for a consistent approach to evaluate road marking formulations with minimal variability of test results. There is also a need for an evaluation system to quantify the forces needed to dislodge glass beads from the road marking that would help evaluating road marking formulations during the qualification process.

### SUMMARY

In one aspect, the disclosure relates to a test method for the evaluation of glass bead retention in a road marking. The method comprises applying a road marking composition onto a substrate forming a road marking layer; positioning at least a glass bead onto the road marking layer; securing at least a portion of the glass bead in a gripping mechanism of a tensile tester; operating the tensile tester at a speed for a sufficient force to dislodge the glass bead partially or completely from the road marking layer; and recording the amount of force required to dislodge the glass bead partially or completely from the road marking layer.

In another aspect, the test method comprises: providing a road marking composition; heating the road marking composition to a temperature of at least 130° C. for the road marking composition to be in a molten form; applying the molten road marking composition onto a substrate forming a road marking layer; positioning at least a glass bead onto the road marking layer; allowing the road marking layer to cool down to a temperature in the range of −20 to 60° C.; securing at least a portion of the glass bead in a gripping mechanism of a tensile tester; operating the tensile tester at a speed and sufficient force to dislodge the glass bead partially or completely from the road marking layer; and recording the force required to dislodge the glass bead partially or completely from the road marking layer.

In another aspect, the disclosure relates to a test method for the evaluation of glass bead retention in different road marking formulations. The method comprises providing a plurality of road marking formulations, and evaluating the force required to dislodge glass beads from the formulations employing the test method previously disclosed. The performance of the various formulations can be evaluated by comparing the amount of force required to dislodge a glass bead partially or completely from the various road marking layers.

In yet another aspect, a system to evaluate the force required to dislodge glass beads from a road marking is disclosed. The system comprises: a platform for applying a road marking layer on a substrate at a pre-determined thickness; a means for positioning at least a glass bead in the road marking layer for testing; a tensile tester for measuring force on and displacement of the glass bead positioned in the road marking layer; an optional tilting mechanism for holding the road marking and backing substrate with glass beads in place at the desired angle to tensile tester; a gripping component operably coupled with the tensile tester for locking the glass bead in position while the tensile tester exerts a vertical force on the glass bead for measuring the force required to dislodge the glass bead partially or fully from the road marking layer.

### DESCRIPTION OF THE DRAWINGS

FIG. 1 is a photograph showing a coating table for use in a system for evaluating glass retention in road markings.

FIG. 2 is a photograph showing an embodiment of an evaluation system, with a movable coating arm running on tracks parallel to a length of substrate to be coated with a road marking formula.

FIG. 3 is a photograph showing a number of rods for positioning glass beads at predetermined positions on a substrate coated with the road marking formula.

FIG. 4 is a photograph showing a system with a coating table and a universal testing device to measure displacement and pull-off force of glass beads from road markings.

FIG. 5 is a photograph showing an embodiment of a pull-off test before application of tensile force.

FIG. 6 is a photograph showing the pull-off test in FIG. 5 after application of tensile force after the glass bead is pulled off.

### DESCRIPTION

As used herein, “glass beads” refer in general to components that can be used to enhance the reflective properties of road markings, including glass microspheres, glass beads, ceramic beads, plastic beads, and the like, as long as they are of sufficient size and shape for the measurement of pull-off force from road markings as described in this disclosure.

“Road marking” may be used interchangeably with “marking” or “marking paint” or “traffic stripe” or “coating”, referring to lines, symbols, and patterns painted or applied on road surfaces to provide information, guidance, and regulation to drivers and pedestrians.

“Road” may be used interchangeably with pavement.

Different countries and governmental agencies have their own internal and independent pavement marking specifications. In the US, state agencies specifications are normally based on some variation of AASHTO (American Association of State Highway Transportation Officials) designation M-249 and T-250, a federal specification setting minimum and basic requirements of the materials to be used. For Europe, specifications are set according to EN1871 and EN1427. Typically, there are standards for minimum reflectivity in road markings. Glass bead retention in road markings correlates directly with reflectivity. The disclosure relates to a method that can be used in conjunction with existing governmental standards to evaluate road marking formulations based on glass bead retention property by measuring the pull-off force of glass beads from the road marking. The disclosure also relates to an evaluation system, allowing for greater insight into the formulation of road markings, and/or for the evaluation of formulations during the qualification process.

Road Marking Types/Formulations: The method can be used to evaluate various road marking formulations, including formulations to form surface markings applied using mechanical or non-mechanical devices forming different marking types. The formulations can be any of paint, thermoplastic markings (such as hydrocarbon resins or polyethylene resins or polypropylene resins or polyamide resins or rosin ester resins or alkyd resins), pre-formed polymer tape, pre-formed thermoplastic, thermosetting markings (such as epoxy or polyurethane or methyl methacrylate or polyurea), and other road marking types. Mechanical road surface markers involve physical elements or materials placed directly on the road surface. They may be raised or recessed into the road surface, e.g., Botts' dots, rumble strips, pre-painted lines. Non-mechanical markers do not involve physical elements but rather use paints or materials to create patterns, symbols, or information. The markings can be any of longitudinal lines, e.g., edge and centerlines, a continuous line, or a skipped/dashed line; or transverse markings such as stop bars, chevrons, traffic taming markings, bike and pedestrian crossings, railroad crossings, or similar markings; or symbols, e.g., bike lane makings, handicap markings, railroad crossing, highway shield. The markings can be for public and private highways, properties, airports, and parking lots.

The method can be used to measure the pull-off force (or bond strength) of glass beads as applied to road marking formulations by either of two methods: a) marking paint formulations for mixing with glass beads before application, with the paint compositions being formulated to allow the beads to be evenly distributed throughout the paint and applied to the road surface at the same time as the paint, with the beads being embedded within the marking; and b) road marking formulations to be first applied onto the road surface, followed by spraying or scattering of glass beads onto the paint while it is still wet, with the beads being right on the road surface providing better initial retroreflectivity.

Road marking formulations can vary based on manufacturer specifications, regional regulations, and performance requirements. Additionally, the choice of glass bead size, type, and gradation may also influence the formulation to achieve the desired retroreflectivity and performance characteristics. In embodiments, a premixed glass bead road marking paint formulation comprises: 15-30% binder, 30-40% fillers, up to 15% optional pigments, 15-45% glass beads, up to 10% optional solvents, and <2% optional additives. For road marking paint designed for post-applied glass beads, the formulation is similar to premixed paint, but it does not contain reflective glass beads. Instead, glass beads are applied separately.

Binder refers to a component that softens when heated and solidifies when cooled. Common binders include hydrocarbon resins, rosin resins, elastomers, plastomers, alkyd resins, EVA (ethylene vinyl acetate) copolymers, and mixtures thereof. In embodiments, rosin resins or hydrocarbon resins are present in amounts of 10 to 90 wt. % of the binder. Exemplary rosin resins include rosin esters, acrylic rosin esters, disproportionation rosin esters, dibasic acid modified rosin esters, polymerized resin esters. Exemplary hydrocarbon resins include C5 aliphatic hydrocarbon resins, C9 aromatic hydrocarbon resins, and C5/C9 hydrocarbon blend. Exemplary elastomers include but are not limited to natural rubber, isoprene rubber, styrene-butadiene rubber, chloroprene rubber, butadiene rubber, nitrile butadiene rubber, isobutylene-isoprene rubber, ethylene-propylene diene monomer, urethane rubber, silicone rubber, fluorocarbon rubber, styrene-isoprene-styrene rubber, styrene-butadiene-styrene rubber, styrene-ethylene/butylene-styrene, styrene-ethylene/propylene-styrene, ethyl vinyl acetate (EVA), graft copolymers of EVA with another monomer such as vinyl chloride, a hot-melt polyamide resin, and mixtures thereof.

In embodiments, the road marking formulations to be evaluated can be made by melt mixing all components together, or with some of the component(s), e.g., binder(s) pre-mixed in the form of pellets, before melt mixing with the remaining component(s).

In other embodiments, road marking formulations to be evaluated are made by mixing components together (without heat) and cured or dried.

Glass Beads: With respect to the glass beads used in the road marking formulations for evaluation, they can be any of uncoated glass beads or coated glass beads, of different sizes and materials of construction, for use as pre-mixed (intermix) or drop-on glass beads. The evaluation method disclosed herein can work with glass bead of various types and sizes. For example, small beads typically have a diameter from approximately 100-300 μm for pavement markings on low-traffic roads and in areas with reduced visibility requirements; intermediate beads of 600-850 μm for a wide range of road marking applications, including local roads, and parking lot; and large beads of 600-850 μm for use in highway and high-traffic road markings.

Any of intermix beads and drop-on beads can be evaluated with the disclosed method. Intermix beads are included in the hot melt and contained throughout the bulk of the marking. Drop-on beads are applied immediately following application of the road marking while the material is still molten, before it is cured, or before drying, depending on type.

Beads of any size can be used for the retention evaluation depending on the evaluation method, e.g., pull-off force or peel-off force. For the pull-off force test, the beads for use in the evaluation should be of a larger size, e.g., >500 μm with borehole, are preferred for use.

If the glass bead retention evaluation is for comparing various road marking formulations with consistent test parameters, and not necessarily to measure the pull-force of glass beads applied in formulations as pavement markings, larger beads can be used for testing. The beads can be >0.5 mm, or >1 mm, or >2 mm, or >3 mm, or >5 mm, or >8 mm, or >10 mm, or 0.1 to 10 mm, or <15 mm in size. In embodiments, the beads are provided with boreholes (as through hole or blind hole).

It is noted that the glass beads are not necessary to be spherical in shape, they can be square, cube, cylinder, cone, pyramid, torus, ellipsoid, prism, and polyhedron. The size here is in reference to the length between the two end holes, or the length of the longest dimension, whichever is greater.

Glass Bead Retention Evaluating System: The ability for a road marking to retain the glass beads during impacts from traffic or changing environmental conditions is directly related to its effectiveness and durability. In this method, the road marking's effectiveness and durability is evaluated by quantifying its ability to prevent the glass beads from being dislodged. The method is particularly useful for the evaluation of multiple road marking formulations, with similar test evaluation parameters for different formulations and with minimal variability of test results for different batches (or runs) of the same formulation.

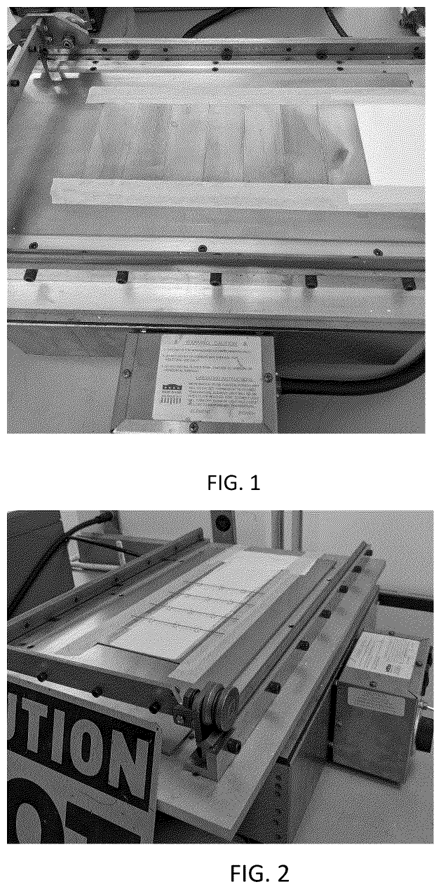

Glass bead retention can be evaluated in a lab, with a coating table for the application or spreading of the road marking composition. As shown in FIG. 1, the coating table is to ensure having a controlled thickness of road marking on a flat object (i.e., a substrate). In embodiments, the substrate comprises a material that can withstand a high temperature for the coating of a molten road marking formulation, e.g., any of glass, metal, plastics, roofing rolls, etc.

In embodiments, the substrate is a removable sheet, allowing the substrate coated with the road marking to be removed from the table for further evaluation, e.g., for a peel force test. In embodiments, the substrate is a flat plate affixed to the coating table, with the coating table being tiltable, and with the tensile tester being in proximity of the coating table to carry out the peel force test.

In embodiments, the coating table is set up such that one edge of the table can be moved up or down independently of the other. The tilting of the coating table allows the simulation of road marking from flat to sloped pavements, as well as the dislodging of glass beads from road marking by rolling vehicle tires (at different rolling angles depending on the tire size). In embodiments, the coating table is provided with an adjustable tilt mechanism allowing for control over the angle at which the table, i.e., the substrate, is inclined, at an angle of 10-85, or 20-70, or 25-60 degrees.

In embodiments, the coating table is provided with heating elements for uniform pre-heating and/or ensuring the substrate and the road marking being kept at the target temperature, e.g., between 120-220° C. or at a typical melting temperature for a road marking composition. The coating table can be further provided with heating sensors/thermocouples to monitor/control the temperature of the substrate and road marking paint applied thereon.

The system is provided with means to spread the road marking composition onto the substrate of the coating table, simulating the application of the composition onto a pavement. In embodiments as shown in FIG. 2, the coating table is provided with a movable coating arm positioned perpendicular to the substrate and running on tracks parallel to the length of the substrate, allowing the road marking formulation to be spread evenly on the substrate at a desired thickness. The coating arm can be positioned up or down (in height or distance from the substrate surface, creating a gap) to control the thickness of the road marking paint spread onto the substrate. Depending on the gap size selected for the movable coating arm, the coating thickness can be up to 30 mm. Typically for tests, coating is applied for a thickness of 1-5 mm, or 0.2-3 mm, or 0.5-0.9 mm, or 0.6-0.8 mm, or >0.5 mm and <1 mm.

As bead embedment depth in pavement marking impacts the retroreflectivity and durability of the road marking material, the system includes means to control the embedment of the glass beads at a controlled and/or pre-determined depth. This helps ensure the same testing conditions if multiple road marking formulations are evaluated.

In embodiments (not shown), the system comprises a drop-on or a pressure-type bead dispenser to evenly drop, embed, and/or anchor the beads at a controlled depth across the formulations to be tested. In other embodiments shown in FIG. 3, there are a number of stiff rods positioned perpendicular to the length of the substrate. The rods are for inserting through the boreholes of the beads (to be embedded into the road marking paint for evaluation). In embodiments, the rods are graduated with markings that can be used for positions or distances for the glass beads to be placed along the rods and subsequently for embedding onto the road marking layer. In some embodiments, there are slots at different height levels along the coating table for the rods to be positioned at different height (relative to the substrate), allowing the beads to be pressed down into the road marking layer to a pre-determined depth. Removable collars can be provided on both or one side of the beads to keep the beads in place, then removed after the beads are embedded in the applied road marking paint.

In embodiments, the system further includes a caliper ruler to measure the embedment depth of the glass beads.

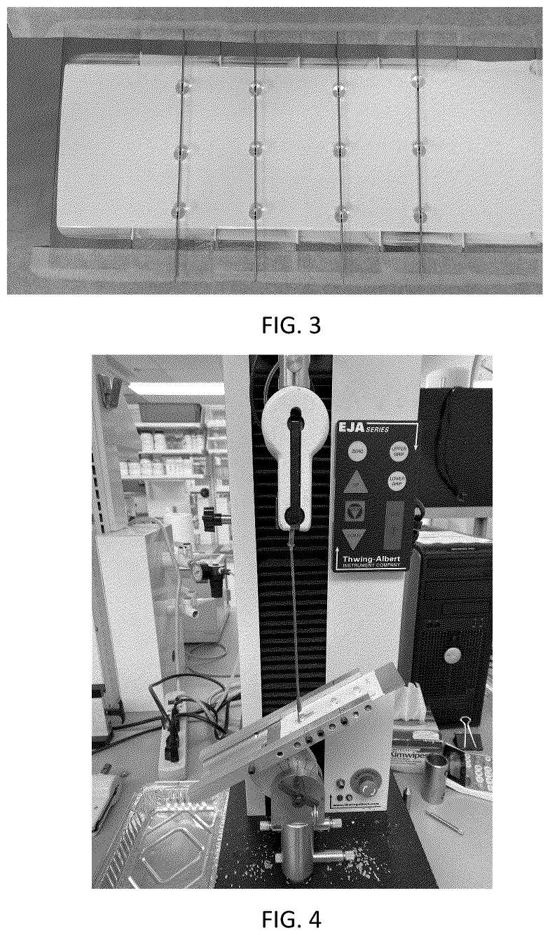

As shown in FIG. 4, the system includes a universal testing device (tensile testing device) that simultaneously measures the displacement (by pulling off) of the glass beads as well as the stress (force) required to pull-off the glass beads either fully or partially, causing dislodgement. Universal testing devices are known in the art and commercially available for performing tension, compression, flexure, and peel/adhesion tests.

The testing device is provided with gripping mechanisms, holding means, e.g., a gripping component or a specimen grip operably coupled with the tensile tester, for a proper grip or lock on the glass bead so that it will not slip or become misaligned during the test, e.g., tensile grip jaws, specimen grips, clamps, and the like. In embodiments, a lanyard with one end attached to the tensile tester, and the other lanyard end has clips or other means at the end for clipping, or hooking onto the beads via the boreholes, e.g., S-hooks or Z-shaped hooks, stiff rods, commercially available miniature specimen grips, and the like. In embodiments, the lanyard end is equipment with a lever in the form of a miniature harness, ripping claws, or crowbar for wrapping around the glass bead, or for prying the glass bead loose from the coating.

In embodiments, the pull-off force (or bead bonding strength) is measured as the amount of force required to pull-off glass beads when a pressure-sensitive adhesive (PSA) tape is applied firmly against the substrate coated with the road marking, and thereafter removed after the PSA pulled off at a pre-determined angle from the road marking surface have the glass beads embedded therein. The use of the PSA tape is particularly useful with smaller beads without having through boreholes.

Method to Evaluate Bead Retention Capacity of Marking Formulations: In the preparation step, a road marking composition (without intermix glass beads) is formulated and applied to a substrate. In embodiments, the road marking composition is heated for a target molten temperature of 130-220° C. and applied to a substrate. The composition is spread out evenly onto the substrate to a desired thickness. In embodiments, the substrate is on a coating table with the composition spread with a coating bar. Weigh the glass beads. After the material is evenly applied on the substrate at a preset coating thickness, press or embed the glass beads into the coating at a pre-set depth, e.g., a depth wherein the boreholes are exposed above the road marking surface. After the glass beads are pulled off (or peeled off), weigh the beads to measure the amount of road marking transferred to the glass beads.

In embodiments of the pull-off test, the specimen grip or the gripping component is positioned to firmly clamp or lock onto the glass bead through its borehole (through hole or blind hole). As the tensile tester is initiated, the machine will gradually apply a pulling force in the vertical direction away from the glass bead until portion(s) of the glass bead are pulled off or broken off. In embodiments depending on coating type, the tensile tester is operated at a tensile speed of 5 mm/min to 400 mm/min, or >2 mm/min, or >10 mm/min, or 10-30 mm/min, or <40 mm/min. The substrate (or sample fixture) being tilted at an angle of 0-90, or 15-50, or 20-40, or >=30, or 35-40 degrees. Record the pull-off force and collect the dislodged glass beads. Weigh the dislodged beads and calculate the amount of road marking transferred to the bead.

In embodiments, a different method using a peel-off test with an adhesive coated tape is employed. Adhesive coated tape (PSA) can be according to U.S. Pat. No. 6,403,206B1, incorporated herein for reference, having a lengthwise elongation at break of from about 50% to about 1200%, and a Young's modulus of less than about 2400 psi. The pressure sensitive adhesive (PSA) or hot melt adhesive sample can be prepared with dimensions identical to the substrate coated with the road marking layer. In embodiments, for the substrate, a road marking composition is heated until molten and then evenly spread onto the heated substrate. In other embodiments, for the substrate, the road marking composition is evenly spread onto the substrate without heating. Drop-on beads are applied onto the marking in molten state or before the road marking composition has cured or dried (depending on the type of composition). After the marking (with beads) is cooled down to room temperature (in the range of −20 to 60° C.) or cured/dried, a PSA is applied to the cooled or cured/dried marking surface. Loose beads are then removed from the surface of the road marking sample by peeling off the PSA with a tensile tester. If necessary, the PSA sample and the coated substrate are cut to size for the tensile tester. Weigh the pieces before securely bonding the PSA tape to the coated substrate for testing. Place the specimen (PSA bonded to the marking sample) in the grips of the tester, ensuring that the bonded area is securely held.

The peel-off test is conducted at a constant rate of peel as standard for adhesive peel testing per ASTM D3330. Record the force and displacement (or pulling off) of the glass beads embedded in the road marking layer. Weigh the pulled off adhesive tape and the substrate after the test is completed to estimate the amount of dislodged glass beads.

It there are multiple road marking formulations evaluated (e.g., ranking of performance), then it is imperative that the setup be the same for all formulations, e.g., marking layers of the same thickness for the different formulations, same glass beads are used, glass beads are positioned at the same position(s) on the road marking/substrate, same tensile speed, tilt angle of the substrate, etc., for consistent testing parameters and criteria.

The system set up as described provides a method to evaluate road marking formulations with consistency and reproducibility, with minimal variations between batches of the same formulations (assuming all things equal). In embodiments of the pull-off test, the standard deviation (STD) of the force required (in N) to pull off the glass bead is <25%, or <20%, or <10% (with test samples of 7 batches of each road marking formulation). The system and the method further allow evaluators to vary and test different parameters for road marking formulations, e.g., coating thickness, density of glass beads (e.g., number of glass beads per surface area), size of glass beads, degree of difficulty in spreading, pull-off force at different road angles, etc. Test results and parameters can be helpful in specifying standards and requirements for road marking formulators.

Examples: The following examples are non-limiting, illustrating data obtained in an evaluation comparing the pull-off force and retention data (as % of glass beads that are dislodged) for different road marking formulations, as well as the reproducibility of the test method.

Examples 1-4: A number of road marking compositions were formulated with the components as shown in Table 1. SYLVACOTE™ 4984, SYLVACOTE™ 4995, SYLVALITE™ RE100L, and SYLVABIND™ C200 are binder products all from Kraton Corporation for road marking applications. SYLVABIND C200 is a blend glycerol ester of maleated rosin and a thermoplastic polymer. In the examples, the steps specified below were followed for all examples for all batches (up to 7 batches) of the same formulation, and for all different formulations to be evaluated the same way.

Blend the components together with overhead stirring in heating mantel to a melting temperature of about 195° C. Set up a coating table as illustrated in FIG. 1 and heat the substrate to be coated to at least 130° C. Preheat the coating bar and glass beads to the same temperature of at least 130° C. for a thermoplastic material. Pour the molten road marking composition onto substrate of the coating table. Slowly push the coating arm down the table to apply the road marking to an even thickness of about 0.6 mm.

Record the weight of the glass beads. String the glass beads onto the stiff rods. Position the stiff rods and align the rods to be parallel with each other in pre-set slots for the beads to be seated in pre-determined positions in the road marking layer. Turn off the heating of the coating table and allow the system to cool to room temperature. After the system cools off, remove the rods leaving the glass beads positioned in the coating.

Separate the coated test panels and place them into the tilting fixture attached to the tensile tester. Tilt the sample holding fixture to a 30° angle setting. Attach a lanyard having a fisheye at an end to the tensile tester as shown in FIG. 5 and position the fisheye to line up with the borehole in the bead to be tested (pulled off). Insert a stiff rod through fisheye with its stem on one side with the fisheye, and the other end on the other side of the fisheye and through the glass bead borehole. Cap the end of the stiff rod with a rubber collar to keep the glass bead firmly positioned next to the fisheye (of the lanyard cable).

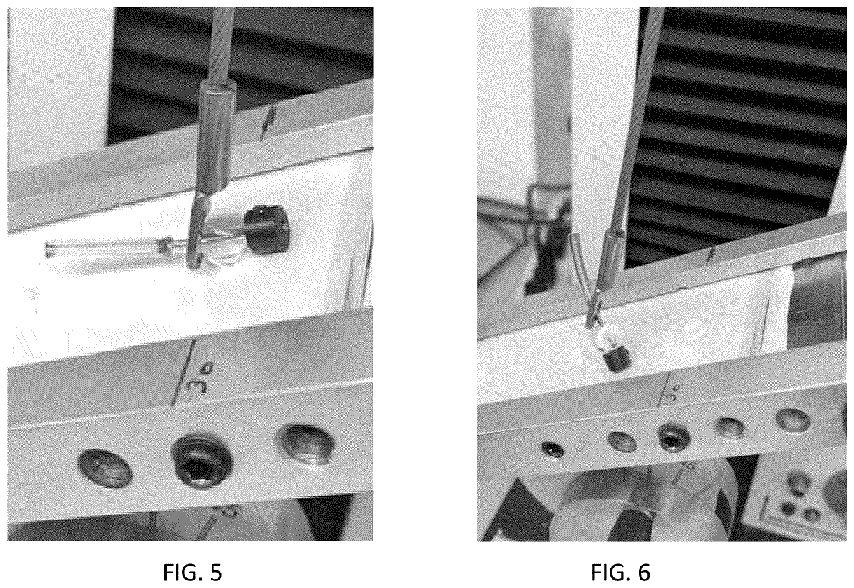

Run the tensile tester at a target speed of 20 mm/min. After the glass bead is pulled off the road marking as shown in FIG. 6, record the maximum pull-off force and elastic modulus, and also record the weight of the substrate and whatever remains of the glass bead (if any) after the pull-off test. In addition to the force, also record the displacement distance of the glass bead from its starting position. Repeat the testing of each formulation at least twice for reproducibility. Coating thickness is in mm, and viscosity is in cps. Viscosity is measured just before the molten formulation is poured onto the coating table (at about 195° C.).

TABLE 1

| Components (grams) | Example 1 | Example 2 | Example 3 | Example 4 |
|---|---|---|---|---|
| SYLVACOTE 4984 | 2.5 | 2.5 | 0.0 | 0.0 |
| SYLVACOTE 4995 | 0.0 | 0.0 | 2.5 | 8.2 |
| SYLVALITE RE100L | 7.8 | 7.8 | 7.8 | 7.8 |
| SYLVABIND C200 | 6.7 | 0.0 | 0.0 | 0.0 |
| SYLVABIND C200 | 0.0 | 6.7 | 0.0 | 0.0 |
| SYLVABIND C200 | 0.0 | 0.0 | 6.7 | 0.0 |
| Ethylene vinyl acetate | 0.0 | 0.0 | 0.0 | 1.0 |
| Castor oil | 2.0 | 2.0 | 2.0 | 2.0 |
| TiO₂ | 10.0 | 10.0 | 10.0 | 10.0 |
| Calcium carbonate | 36.0 | 36.0 | 36.0 | 36.0 |
| Glass Beads | 0 | 0 | 0 | 0 |
| Total | 100.0 | 100.0 | 100.0 | 100.0 |
| Force (N) | 61.9 | 58.3 | 67.3 | 55.0 |
| Thickness (mm) | 0.61 | 0.63 | 0.61 | 0.67 |
| Viscosity (cP) | 3075 | 3250 | 2633 | 2981 |

Examples 5-6: The steps in Examples 1-4 are repeated with different formulations as shown in Table 2, with the tests being repeated 7 times with 7 batches of each of the 2 road marking formulations. Table 3 shows the excellent reproducibility/minimal variability of test results with the pull-off evaluation test method. Coating thickness is in mm, and viscosity is in cps. Viscosity is measured just before the molten formulation is poured onto the coating table (at about 195° C.).

TABLE 2

| Components (gram) | Example 5 | Example 6 |
|---|---|---|
| SYLVACOTE 4995 | 12.6 | 3.8 |
| SYLVALITE RE100L | 12.0 | 12.0 |
| SYLVABIND C200 | 0.0 | 10.3 |
| Ethylene vinyl acetate | 1.5 | 0.0 |
| Castor Oil | 3.1 | 3.1 |
| TiO2 | 15.4 | 15.4 |
| Calcium Carbonate | 55.4 | 55.4 |
| Glass Beads | 0 | 0 |
| Total, grams | 100.0 | 100.0 |

TABLE 3

| Example 5 | | | | Example 6 | | | |
|---|---|---|---|---|---|---|---|
| | Force | Coating | Viscosity | | Force | Coating | Viscosity |
| Batch # | (N) | thickness (mm) | (cP) | Batch # | (N) | thickness (mm) | (cP) |
| 1 | 57.6 | 0.69 | 2775 | 1 | 74.5 | 0.64 | 2525 |
| 2 | 51.4 | 0.68 | 3025 | 2 | 69.8 | 0.59 | 2475 |
| 3 | 47.3 | 0.60 | 2975 | 3 | 62.0 | 0.58 | 2500 |
| 4 | 60.3 | 0.70 | 3150 | 4 | 61.9 | 0.61 | 3075 |
| 5 | 40.5 | 0.65 | 3225 | 5 | 71.7 | 0.60 | 2550 |
| 6 | 36.2 | 0.63 | 3225 | 6 | 62.2 | 0.64 | 2900 |
| 7 | 51.6 | 0.62 | 2800 | 7 | 63.5 | 0.61 | 2850 |
| Ave. | 49.3 | 0.65 | 3025 | Ave. | 66.5 | 0.61 | 2696 |
| STD | 8.7 | 0 | 188 | STD | 5.3 | 0.02 | 240 |

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A method to evaluate amount of force required to dislodge glass beads from a road marking, the method comprises:
applying a road marking composition onto a substrate forming a road marking layer;
positioning at least a glass bead onto the road marking layer;
securing at least a portion of the glass bead in a gripping mechanism of a tensile tester;
operating the tensile tester at a speed for a sufficient force to dislodge the glass bead partially or completely from the road marking layer; and
recording the amount of force required to dislodge the glass bead partially or completely from the road marking layer.

2. The method of claim 1, further comprising:
heating the road marking composition to a temperature of at least 130° C. for the road marking composition to be in a molten form prior to applying the road marking composition onto a substrate a road marking layer.

3. The method of claim 2, further comprising:
allowing the road marking layer to cool down to a temperature in the range of −20 to 60° C. before securing at least a portion of the glass bead to the gripping mechanism of a tensile tester.

4. The method of claim 2, wherein the road marking composition is a thermoplastic road marking comprising hydrocarbon resins, polyethylene resin, polypropylene resin, polyamide resin, rosin ester resin, alkyd resins, or mixtures thereof.

5. The method of claim 1, further comprising removing the substrate having the road marking layer applied thereon for securing onto the tensile tester.

6. The method of claim 1, further comprising measuring displacement distance of the glass bead.

7. The method of claim 1, further comprising:
obtaining a weight X of the glass bead prior to positioning the glass bead onto the road marking layer;
obtaining a weight Y of the dislodged glass bead after operating the tensile tester; and
subtracting the weight X from the weight Y to compute weight of the road marking composition transferred from the road marking layer to the dislodged glass bead.

8. The method of claim 1, wherein the road marking composition is a thermoset road marking comprising epoxy, polyurethane, methyl methacrylate, polyurea, or mixtures thereof.

9. A method to evaluate performance of different road marking compositions by amount of force required to dislodge glass beads from the different compositions, the method comprising:
providing the different road marking compositions for evaluation; and
carrying out the steps in the method of claim 1 for each of the road marking compositions to be evaluated to obtain the force required to dislodge a glass bead partially or completely from the road marking layer.

10. A system to evaluate force required to dislodge glass beads from a road marking composition, the system comprises:
a platform for applying a road marking composition onto a substrate, forming a road marking layer on the substrate at a pre-determined thickness;
means for positioning at least a glass bead in the road marking layer for testing;
a tensile tester for measuring force required to dislodge the glass bead from the road marking layer; and
a gripping component operably coupled with the tensile tester for locking the glass bead in position while the tensile tester applies a force on the glass bead to fully dislodge the glass bead from the road marking layer.

11. The system of claim 10, wherein the substrate comprises a plurality of sections allowing multiple evaluations of coated substrate sections at same time.

12. The system of claim 10, wherein the substrate is removable from the platform.

13. The system of claim 10, further comprises a tilting mechanism for tilting the platform and/or the substrate.

14. The system of claim 10, wherein the glass beads for evaluation are provided with bore holes.

15. The system of claim 10, wherein the tensile tester applies a vertical force on the stiff rod to create a torsional force on the glass bead to dislodge the glass bead.

16. The system of claim 10, wherein the means for positioning the glass bead is a string for holding the glass beads in position in the road marking layer, and wherein the string is removed after the glass beads are placed in position.

17. The system of claim 16, wherein the string is a stiff bar.

18. The system of claim 10, wherein the glass beads for evaluation have an average size of 0.1 to 15 mm.

19. The system of claim 10, further comprising a movable coating arm positioned perpendicular to the substrate and running on tracks parallel to length of the substrate to spread the road marking composition evenly on the substrate for a desired thickness.

20. The system of claim 19, wherein the movable coating arm is adjustable for an up or down position to control the road marking layer thickness.
